(19) United States
(12) Patent Application Publication
(10) Pub. No.: US 2013/0309546 A1
(43) Pub. Date: Nov. 21, 2013

(54) CELL CASE FOR SECONDARY BATTERY

(71) Applicant: Sung Chul Park, Daejeon (KR)

(72) Inventor: Sung Chul Park, Daejeon (KR)

(73) Assignee: SK INNOVATION CO., LTD., Seoul (KR)

(21) Appl. No.: 13/991,779

(22) PCT Filed: Dec. 6, 2011
(86) PCT No.: PCT/KR11/09370

§ 371 Date: Jun. 5, 2013

(30) Foreign Application Priority Data
Dec. 13, 2010 (KR) 10-2010-0126808

(51) Int. Cl. H01M 2/02; H01M 10/50

(52) U.S. Cl. CPC H01M 2/02; H01M 10/5004
USPC 429/120

(57) ABSTRACT

Provided is a cell case for secondary batteries which protects and supports a bare cell. The cell case has vents, thus enhancing the cooling efficiency of the bare cell. A heat exchanging member is formed in an outer surface of the cell case so that the bare cell can directly dissipate heat to the air through the heat exchanging member. Therefore, the efficiency of cooling the bare cell can be enhanced, thereby improving the performance of the secondary battery.

### TECHNICAL FIELD

The present invention relates to a cell case for secondary batteries which protects and supports a bare cell, and more particularly, to a cell case for secondary batteries which has vents, thus enhancing the cooling efficiency of the bare cell.

### BACKGROUND ART

Generally, secondary batteries are batteries which are designed to be recharged and used multiple times, unlike primary batteries which are designed not to be rechargeable. Secondary batteries are widely used in small high-tech electronic devices, for example, cellular phones, PDAs, notebook computers, etc. Particularly, the operating voltage of lithium secondary batteries is 3.6V which is three times that of nickel-cadmium or nickel-hydrogen batteries which are widely used as power sources of electronic devices. The energy density per unit weight of the lithium secondary batteries is also comparatively high. Therefore, the field pertaining to lithium secondary batteries is growing quickly.

Such secondary batteries are classified into internal batteries and external batteries according to the method of mounting a battery to an electronic device. The internal batteries are well known as the term “inner packs”. Thus, in the following description, the term “inner packs” will be used when describing the internal batteries.

An external battery is itself responsible for forming a portion of the appearance of an electronic device. In other words, the external battery is mounted to a surface of the electronic device and thus exposed to the outside so that the external battery can be simply mounted to or removed from the electronic device. Hence, for the sake of achieving a harmony between the shape of the external battery and the appearance of the electronic device, external batteries must be separately manufactured for different kinds of electronic devices. As such, the compatibility of the external batteries is low. Also, the external batteries must be designed in many different shapes, increasing the production cost.

For such a reason as this, inner packs have recently gained in popularity. Inner packs are installed inside electronic devices. Electronic devices having the inner packs include a separate cover so that an inner pack installed therein can be covered. The use of the separate cover makes it inconvenient to mount the inner pack to the electronic device, but the inner packs can be compatible with different kinds of electronic devices. Also, the inner packs can be designed in simple shapes and thus be easily mass-produced, thereby reducing the production cost.

The construction of such an inner pack will be briefly explained. The inner pack includes pouch type bare cells which are important elements and are stacked one on top of another. A cell case houses each bare cell therein to protect the bare cell and facilitate its installation. The inner pack is configured by stacking the cell cases one on top of another.

The bare cells generate heat while operating. The cell cases reduce the efficiency of heat exchange between the bare cells and the air, resulting in deteriorated performance of the inner pack. To improve the efficiency of heat exchange, using aluminum as the material of the cell cases has been proposed. However, a technique which can more effectively enhance the efficiency of cooling the bare cells is required.

### DISCLOSURE OF INVENTION

### Technical Problem

An object of the present invention is to provide a cell case for secondary batteries which protects and supports a bare cell and is provided with a heat exchanging member formed in an outer surface of the cell case so that heat generated from the bare cell can be dissipated to the air through the heat exchanging member, thus enhancing the cooling efficiency of the bare cell.

The heat exchanging member may be formed through the outer surface of the cell case or formed by bending the outer surface of the cell case and cutting a portion of the outer surface.

### Solution to Problem

In one general aspect, a cell case for a secondary battery includes: a bare cell provided with an electrode tap exposed from one side of the bare cell; and a cell case housing the bare cell therein, wherein a heat exchanging member is formed in an outer surface of the cell case, the heat exchanging member allowing the bare cell to communicate with an outside.

The heat exchanging member may include: a heat exchange path formed by bending a portion of the outer surface of the cell casing in a vertical or horizontal-longitudinal direction; and cutting holes formed by cutting portions of the outer surface of the cell case at opposite ends of the heat exchange path.

The heat exchanging member may comprise a plurality of heat exchanging parts spaced apart from each other by a predetermined distance.

The heat exchanging member may comprise heat exchanging parts provided on a first surface of the cell case, and heat exchanging parts provided on a second surface of the cell case, wherein the heat exchanging parts provided on the first surface alternate with the heat exchanging parts provided on the second surface so that when the cell case is stacked on another cell case, the heat exchanging member between the cell cases are prevented from interfering with each other.

The heat exchanging member may comprise at least one through hole formed through the outer surface of the cell case.

### Advantageous Effects of Invention

In a cell case for a secondary battery according to the present invention having the above-mentioned construction, a heat exchanging member is formed in an outer surface of the cell case, and a bare cell can directly dissipate heat to the air through the heat exchanging member. Therefore, the cooling efficiency of the bare cell can be enhanced and the performance of the secondary battery can be improved.

### BRIEF DESCRIPTION OF DRAWINGS

The above and other objects, features and advantages of the present invention will become apparent from the following description of preferred embodiments given in conjunction with the accompanying drawings, in which:

FIG. 1 is a perspective view of a cell case, according to the present invention.

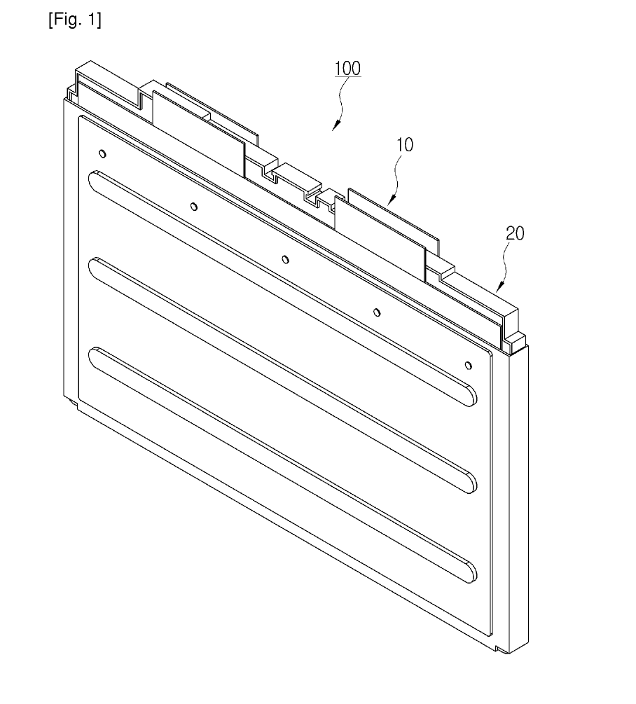

FIG. 2 is a side view showing a stack of cell cases according to the present invention.

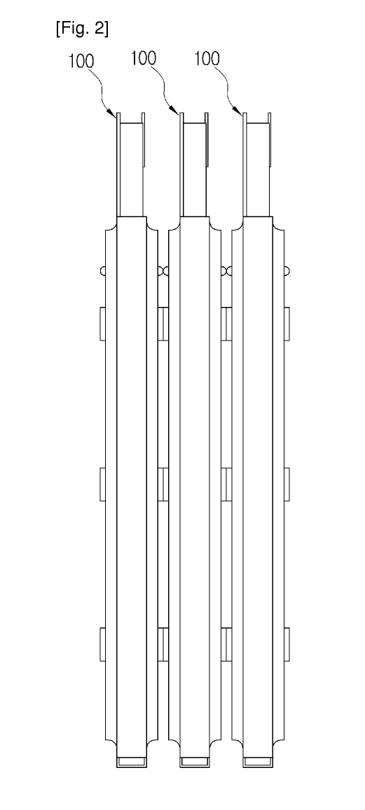

FIG. 3 is an exploded perspective view of a cell case, according to the present invention.

FIG. 4 is a perspective view of a cell case, according to the present invention.

FIG. 5 is an enlarged side view showing a portion of the cell case of FIG. 4.

FIG. 6 is a perspective view of a cell case, according to a second embodiment of the present invention.

FIG. 7 is an enlarged side view showing a portion of the cell case according to the second embodiment of the present invention.

FIG. 8 is a side view showing a stack of cell cases according to the second embodiment of the present invention.

FIG. 9 is a front view of a cell case, according to another embodiment of the present invention.

[Detailed Description of Main Elements]

100: cell module
10: bare cell 11: positive electrode
12: negative electrode
20: cell case 21: upper case
22: lower case
30: heat exchanging member 31, 33: heat exchange path
32, 34: cutting holes 35: through hole

### BEST MODE FOR CARRYING OUT THE INVENTION

Hereinafter, the embodiments of the present invention will be described in detail with reference to the accompanying drawings.

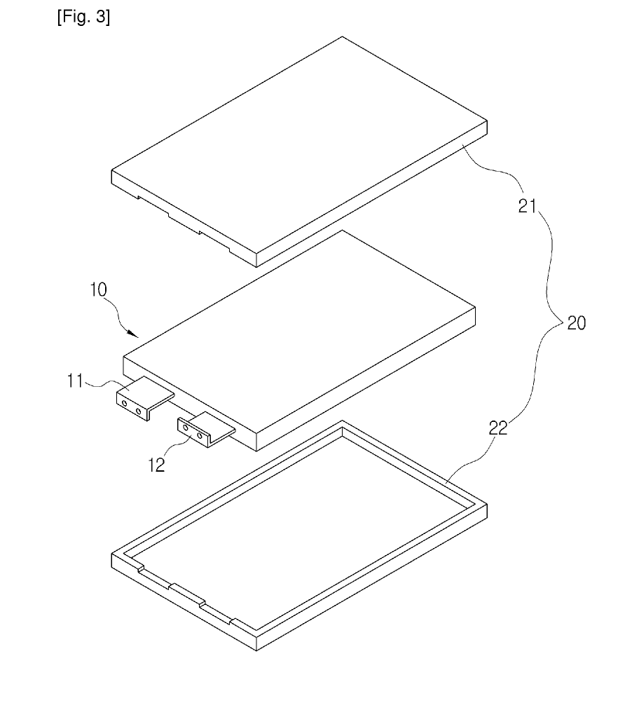

Referring to FIGS. 3 through 5, a cell case for a secondary battery according to the present invention includes a pouch type bare cell 10 and a cell case 20 which contains the bare cell 10.

The shape of the bare cell 10 is that of a pouch, the pouch having a thin aluminum shell. Because the bare cell 10 is easily damaged by external impact, it is contained inside the cell case 20 made of plastic.

Meanwhile, a positive electrode 11 and a negative electrode 12 protrude from a front end of the bare cell 10. The positive electrode 11 and the negative electrode 12 are made of metal, such as copper, aluminum, etc.

Tap terminals (not shown) are attached to the positive electrode 11 and the negative electrode 12. Preferable methods of attaching the tap terminals to the positive electrode 11 and the negative electrode 12 are as follows. The tap terminal for the negative electrode may be adhered to the negative electrode 12 by a seam welding method in which welding surfaces are partially fused by electric resistance and adhered to each other. The tap terminal for the positive electrode may be adhered to the positive electrode 11 by ultrasonic welding. The reason that the seam welding is used for the tap terminal of the negative electrode is because the strength of the material used for the tap terminal of the negative electrode is greater than that of the tap terminal for the positive electrode.

The cell case 20 is manufactured by injection molding using nylon or the like. The reason for using nylon is because the melting point of nylon is comparatively high, specifically, 200° C. or more.

If high current is used to charge or discharge a secondary battery which includes the cell cases of the present invention, heat is generated by resistance at the terminals which are connected to each other in series or parallel. The higher the current is, the higher the temperatures of the terminals. If the melting point of the material used for the cell case 20 is comparatively low, heat generated on the terminals may deform or melt the cell case. Hence, the cell case 20 is preferably made of material having high heat resistance.

The cell case 20 includes an upper case 21 and a lower case 22. The bare cell 10 is contained in the cell case 20 in such a way that the upper case 21 is coupled to the lower case 22 after the bare cell 10 is located between the upper case 21 and the lower case 22.

The structure of the cell case 20 of the present invention is special because it effectively dissipates heat from the bare cell 10 to the air, in other words, it cools the bare cell 10.

A heat exchanging member 30 is formed on an outer surface of the cell case 20. The heat exchanging member 30 may be formed on either of the upper case 21 or the lower case 22 or on both the upper and lower cases 21 and 22.

### First Embodiment

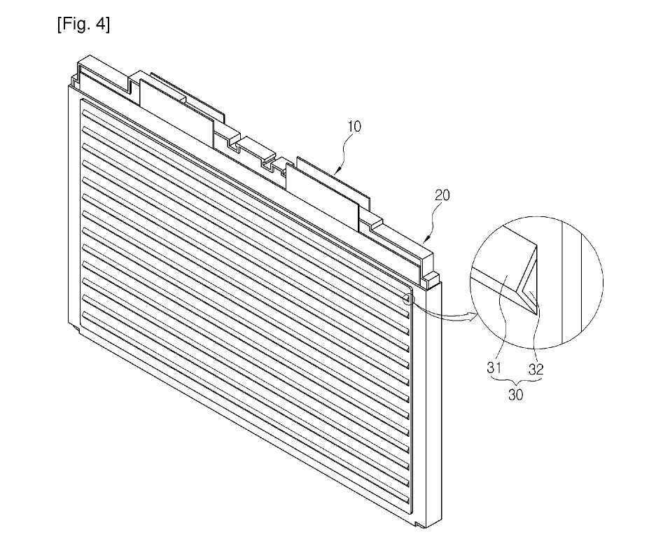

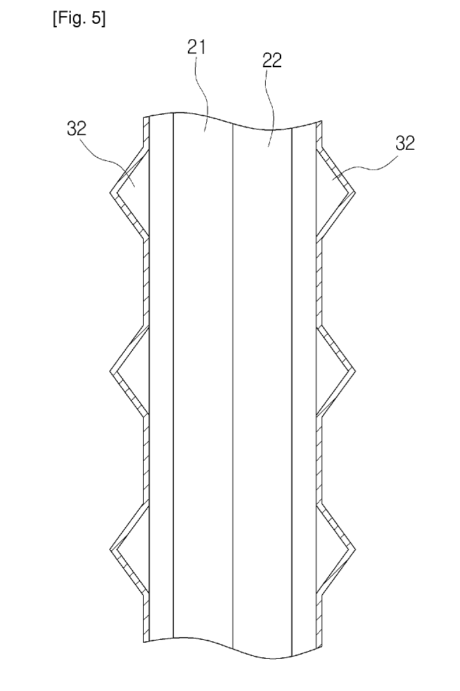

As shown in FIGS. 4 and 5, in this embodiment, a heat exchanging member 30 includes a heat exchange path 31 and cutting holes 32. The heat exchange path 31 is formed by bending a portion of the outer surface of the cell case 20. The heat exchange path 31 extends along the lateral direction of the cell case 20. The cross-sectional shape of the bent portion that forms the heat exchange path 31 is a triangular shape. The heat exchange path 31 is configured such that a corner of the triangular shape protrudes outwards. The heat exchange path 31 is defined along the internal space of the protruding corner. The cutting holes 32 are formed in both ends of the heat exchange path 31. The cross-sectional shape of the heat exchange path 31 is also triangular. The cutting holes 32 are formed by cutting the cell case 20 at both ends of the heat exchange path 31. Thus, heat flows along the heat exchange path 31 and dissipates to the outside through the cutting holes 32.

The heat exchanging member 30 extends in the left and right lateral directions of the cell case 20. The heat exchanging member 30 may comprise a plurality of heat exchanging members which are spaced apart from each other at regular intervals.

### Second Embodiment

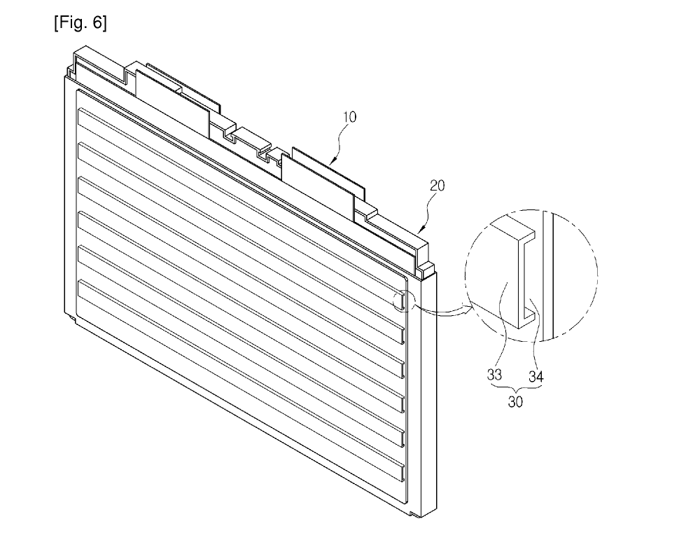

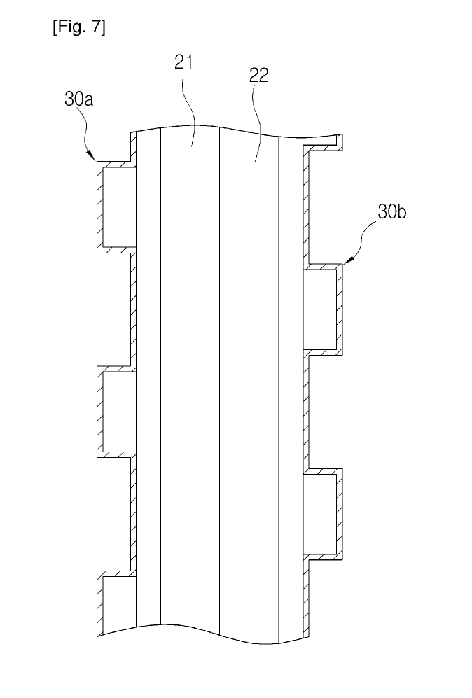

As shown in FIGS. 6 and 7, in this embodiment, a heat exchanging member 30 includes a heat exchange path 33 and cutting holes 34. The heat exchange path 33 is formed by bending a portion of the outer surface of the cell case 20. The heat exchange path 33 extends along the lateral direction of the cell case 20. The cross-sectional shape of the bent portion that forms the heat exchange path 33 is a rectangular shape. The heat exchange path 33 is configured such that it protrudes outwards from the outer surface of the cell case 20. The heat exchange path 33 is defined along the internal space of the protruding portion of the cell case 20. The flow cross-sectional area of the heat exchange path 33 of this embodiment is greater than that of the first embodiment, thus doubling the heat exchange efficiency.

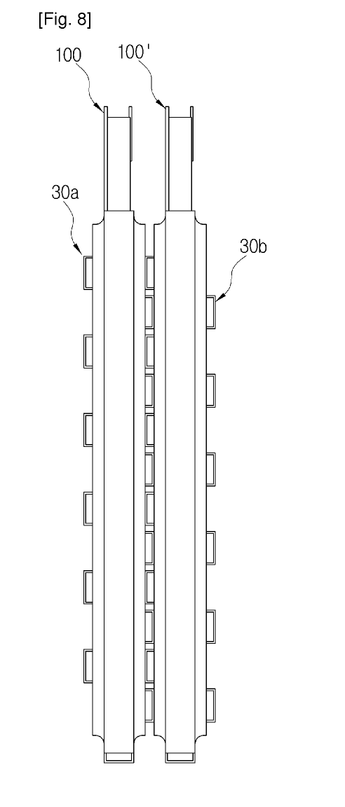

The heat exchanging member 30 may comprise a first heat exchanging parts 30a which is formed on a first surface of the cell case 20, and a second heat exchanging parts 30b which is formed on a second surface of the cell case 20. The first heat exchanging parts 30a and the second heat exchanging parts 30b may alternate with each other so that they are not at the same height. As shown in FIG. 8, in this structure of the heat exchanging member 30, if the cell cases 20 are stacked one on top of another, the heat exchanging parts 30b which are formed on the second surface of the cell case 20 are prevented from interfering with heat exchanging parts 30a which are formed on a first surface of an adjacent cell case 20′, thus making the assembly process easy. The cutting holes 34 are formed in both ends of the heat exchange path 33. The cutting holes 34 are formed by cutting the cell case 20 at both ends of the heat exchange path 33. Thus, heat flows along the heat exchange path 33 and dissipates to the outside through the cutting holes 34.

The heat exchanging member 30 extends in the left and right lateral direction of the cell case 20. The heat exchanging member 30 may comprise a plurality of heat exchanging members which are spaced apart from each other at regular intervals. The distance between adjacent heat exchanging members is preferably greater than the height of each heat exchanging member 30.

### Third Embodiment

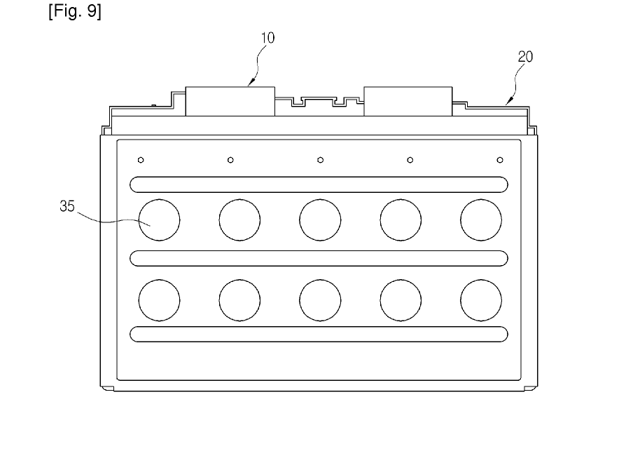

As shown in FIG. 9, a heat exchanging member 30 according to this embodiment comprises a through hole 35 which is formed in the cell case 20 so that the bare cell 10 communicates with the outside through the through hole 35. The through hole 35 comprises at least one, preferably, a plurality of through holes 35, the number of which depending on the capacity of the secondary battery. The size of each through hole 35 may be made larger or smaller depending on the required cooling efficiency. Although the through hole 35 is illustrated as being circular, its shape is not limited as long as the bare cell 10 can communicate with the outside through the through hole 35.

The heat exchanging member 30 of this embodiment which comprises the through hole 35 is advantageous in that it makes the cell case 20 easy to manufacture and promotes rapid heat exchange.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cell case for a secondary battery, comprising:
a bare cell provided with an electrode tap exposed from one side of the bare cell; and
a cell case housing the bare cell therein,
wherein a heat exchanging member is formed in an outer surface of the cell case, the heat exchanging member allowing the bare cell to communicate with an outside.

2. The cell case of claim 1, wherein the heat exchanging member comprises:
a heat exchange path formed by bending a portion of the outer surface of the cell casing in a vertical or horizontal-longitudinal direction; and cutting holes formed by cutting portions of the outer surface of the cell case at opposite ends of the heat exchange path.

3. The cell case of claim 2, wherein the heat exchanging member comprises a plurality of heat exchanging parts spaced apart from each other by a predetermined distance.

4. The cell case of claim 3, wherein the heat exchanging member comprise;
heat exchanging parts provided on a first surface of the cell case, and heat exchanging parts provided on a second surface of the cell case, wherein the heat exchanging parts provided on the first surface alternate with the heat exchanging parts provided on the second surface so that when the cell case is stacked on another cell case, the heat exchanging member between the cell cases are prevented from interfering with each other.

5. The cell case of claim 1, wherein the heat exchanging member comprises at least one through hole formed through the outer surface of the cell case.
